(19) United States
(12) Patent Application Publication
(10) Pub. No.: US 2017/0110038 A1
(43) Pub. Date: Apr. 20, 2017

(54) Lumineye

(71) Applicant: James A. Guertin, Palm Coast, FL (US)

(72) Inventor: James A. Guertin, Palm Coast, FL (US)

(21) Appl. No.: 14/883,363

(22) Filed: Oct. 14, 2015

(51) Int. Cl. G09F 13/20

(52) U.S. Cl. CPC G09F 13/20

(57) ABSTRACT

Disclosed herein is a light absorbent after-glow multilayered coating apparatus comprising a transparent light absorbent member composed of a fabric and a chemical compound incorporated therein, having a front and a back surface. In a preferred embodiment, the invention discloses a luminous paper apparatus to be placed on said items, such as advertising signboards, menu cards, or the like, to enhance the visibility and the readability of the items without utilizing any electrical power or other power sources.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

Field of the Invention

The present invention relates to the field of illuminated signage systems, and, more particularly, to illuminated signboards or menu cards for better reading of the advertisements or other items.

Background of the Invention

Presentation of important information, such as advertisements, directions, or decorative art, often relies on non-illuminated displays. These displays can be difficult to read or view in low-light situations, or can be visually overpowered by surrounding displays of a similar type or by busy backgrounds that tend to camouflage the intended message.

Various reflective materials are commonly employed for safety and decorative purposes. One of the most common principles employed is simply to apply a reflective coating upon the surface of the item, or to construct the item of a highly reflective material, such as polished metal. In addition to reflective coatings and specular surfaces, it is also common to use structures that have various formations that reflect light rays shining thereon, either principally as a result of the steepness of the angle at which the light ray impinges the surface, or by virtue of reflective coatings on the surface of the formations.

Some examples of illuminated signage systems include neon lighting, traditional backlit signs, and front-lit signs. Still others have conceived of using etched, non-opaque materials that are lit from an edge to refract light at strategic points to develop an image. Furthermore, some have used electroluminescent (EL) wire to create images on a surface. The current state of the art has several shortcomings.

Various prior arts have disclosed such illuminating systems. U.S. Pat. No. 5,315,491 A discloses a reflective and luminous layered material that combines the advantages of a light reflective component and a luminescent component provided in sheet form. The sheet is comprised of an overlying layer of prismatic light reflecting material and an underlying layer of luminescent material, wherein latter is selectively energized to become luminous. U.S. Pat. No. 6,152,358 A discloses novelty items that are combinations of articles of manufacture with bioluminescence generating systems and/or fluorescent proteins.

Patent No US 20120248702 A1 discloses a luminous dartboard set that enables a player to easily see the position of a magnetic dart pin struck into a dartboard. It also discloses a printed matter that is printed on a dartboard that allows the player to see the board, even in dark places. WO 1999065679 A1 discloses a luminescent, perforated film that allows, when mounted on a transparent surface, such as a window, an image to be seen when viewed from one side, and a view through the window when viewed from the other side. Another prior art, Patent No US 20140237872 A1, discloses a three-dimensional signboard with improved visual effects, stereoscopic effects, durability, and identifiable display effect of the signboard at night.

There is presently a need for an apparatus that allows the user to achieve much improved reading capabilities to easily and comfortably read advertising signboards, menu cards, or the like. There is also a need for such an apparatus to be lightweight, small, and portable, while still affording the user accessibility to all of the features.

### SUMMARY

In view of the foregoing disadvantages inherent in the known types of luminous sheet systems for illuminating signboards or the like in the prior art, the present invention provides an improved apparatus for improving the visual effect of the signboards for improved readability. As such, the general purpose of the present invention, which will be described subsequently in greater detail, is to provide a new and improved apparatus for making items clearer and be more readable which has all the advantages of the prior art and none of the disadvantages.

The present invention provides, among other things, an illuminated signage system. Particular implementations may further comprise any of the following aspects. In one embodiment, the system includes a printed surface coupled to a first side of a substrate layer. An adhesive sheet is coupled to the opposite side of the substrate layer. A rigid backing substrate is coupled to the adhesive sheet, and at least one luminescent element is embedded over the printed surface.

In a preferred embodiment the invention is a light absorbent after-glow multilayered coating apparatus comprising a transparent light absorbent member composed of a fabric and a chemical compound incorporated therein, having a front and a back surface.

It is an objective of the present invention to provide an illuminated signage system that forms a visually effective image of a symbol, text, number, or combination of these.

Accordingly, it is an objective of the present invention to provide a visibility enhancing material that combines the advantages of a light reflective component and a luminescent component that, in selective regions, is self-luminous without being reflective.

It is another objective of the present invention to provide a unitary visibility enhancing material that is flexible and capable of being mounted on and shaping to surfaces of various configurations, including walls, buildings, signs, clothing, or the like.

There has thus been outlined, rather broadly, the more important features of the invention in order that the detailed description thereof that follows may be better understood, and in order that the present contribution to the art may be better appreciated.

Numerous objectives, features, and advantages of the present invention will be readily apparent to those of ordinary skill in the art upon a reading of the following detailed description of presently preferred, but nonetheless illustrative, embodiments of the present invention, when taken in conjunction with the accompanying drawings. The invention is capable of other embodiments, and of being practiced and carried out in various ways. Also, it is to be understood that the phraseology and terminology employed herein are for the purpose of description, and should not be regarded as limiting.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is perspective view of the present invention.

### DETAILED DESCRIPTION OF THE INVENTION

The embodiments of the present disclosure, described below, are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention, and, together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed, and the subject invention is intended to include all such aspects and their equivalents. Other advantages and novel features of the invention will become apparent from the following detailed description of the invention when considered in conjunction with the drawings.

In some preferred embodiments, the present invention provides improved illuminating apparatus to amplify the visual effects and make things more readable. The purpose of the invention is to provide a user friendly, easy to use illuminating apparatus.

This section summarizes some aspects of the present disclosure, and briefly introduces some preferred embodiments. Simplifications or omissions in this section, as well as in the abstract or the title of this description, may be made to avoid obscuring the purpose of this section, the abstract, and the title. Such simplifications or omissions are not intended to limit the scope of the present disclosure, nor imply any limitations.

In a preferred embodiment the invention is a light absorbent after-glow multilayered coating apparatus comprising a transparent light absorbent member composed of a fabric and a chemical compound incorporated therein, having a front and a back surface.

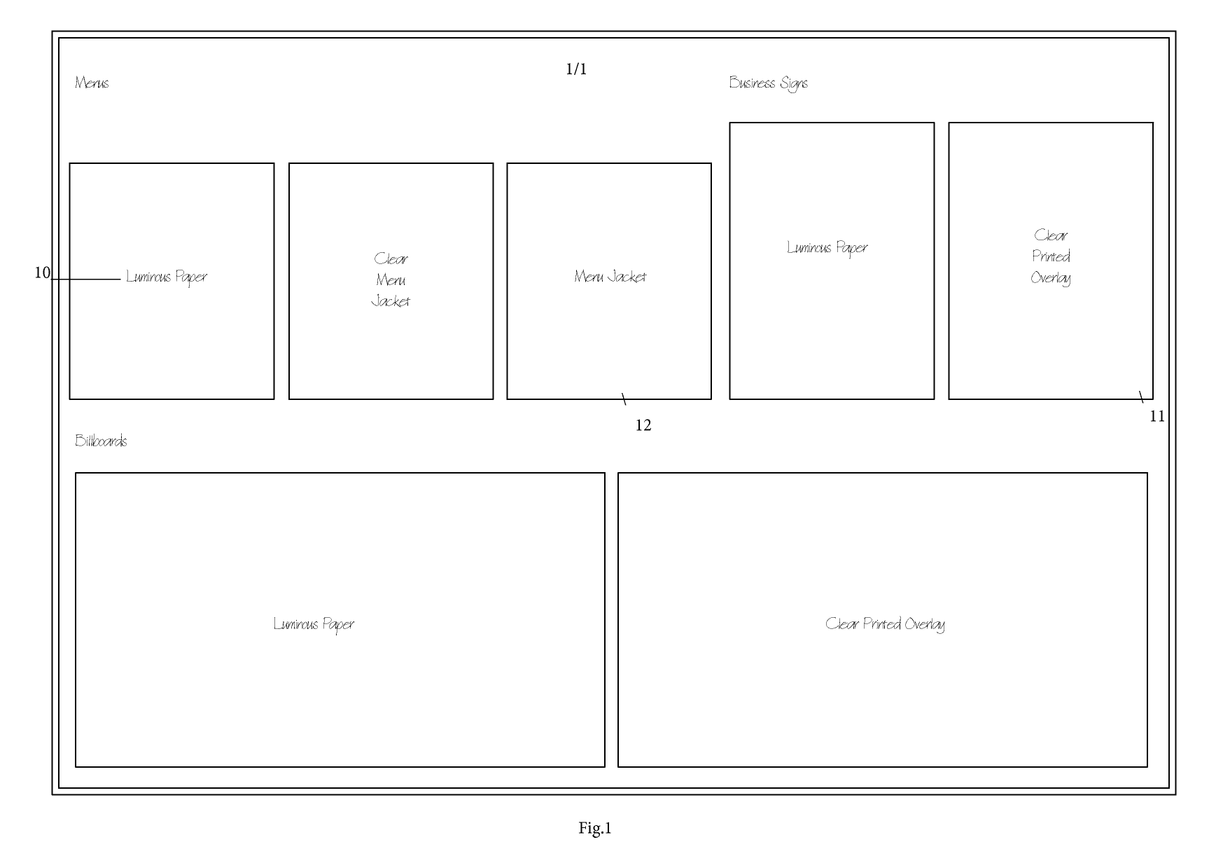

Referring to the invention in more detail, the invention is directed to an illuminating apparatus that includes three important parts: a luminous paper 10, a clear printed overlay 11, and a cover or jacket 12, as shown in FIG. 1. In a preferred embodiment, the disclosed apparatus is made by combining the three important parts and illuminating the signboard or the like. The disclosed luminous paper absorbs any kind of light and makes the covered item glow. The clear printed overlay is attached to give the necessary 3-D effect to the item and make it easier to read.

The present invention provides, among other things, outdoor media signage products that allow for a message or advertisement to be displayed both day and night. Daytime viewing may be accomplished through the use of full color printed graphics, which display a message or advertisement in a well-lit environment, much like traditional signage. However, as lighting in the environment diminishes, the sign can be read through the laminating paper apparatus. This allows for the signage to be illuminated while remaining stationary or fully portable, such as for use in a handheld roadside spinning advertisement, or for use as a cheer or motivational tool.

In some embodiments, the present invention discloses an illuminating apparatus that can be used without any electrical power consumption or batteries. The apparatus just needs to be placed neatly and properly over the advertising signboards, menu cards, or the like to make the contents more clearly visible and readable. The disclosed apparatus utilizes light energy as its driving force, captures the light from any kind of light source, and reflects back the same, thus illuminating the item, board, or card covered with the apparatus.

The scope of the current invention is not limited to the embodiments and the examples described as above, further the present invention could be applied to the following objects an d combination thereof such as:

Business signs, restaurant menus, nightclub menus, billboards, pet products, magnets, car & Boats, BUSINESS CARDS, Standard, Business Cards, Signature Business Cards, Brilliant, Finish Business Cards, Raised Print Business Cards, Spot Gloss, Business Cards, Metallic Finish Business Cards, Ultra Thick Business Cards, Economy Business Cards, Personal Business Cards, Folded Business Cards, Business Card Holders, Networking Cards, Appointment Cards, Parent Cards,

Business Services

Logo Design, Mailing Lists, Postage Meters, CALENDARS, Wall Calendars, Desk Calendars, Magnetic Calendars, Pocket Calendars, Poster Calendars, Gift Certificates,

Corporate Gifts,

Promotional Products, Personalized Mugs, Pens, Bottle Openers, USB Flash Drives, Calculators, Stress Balls, Tape Measures, Letter Openers, Keychain Flashlights, Rulers Magnetic Clips, Mouse Pads,

Custom Clothing,

T-shirts, Men's T-Shirts, Women's T-Shirts, Kids T-Shirts, Polo Shirts, Men's Polo Shirts, Women's Polo Shirts, Hats, Hoodies, Classic Cotton Tote Bags, Promotional Products, Design Services,

Holiday Cards & Gifts,

Photo Calendars, Holiday Cards, Personalized Gifts, Canvas Prints, Personalized Mugs, Phone Cases, Pillows, Puzzles, Coasters, T-Shirts, Labels & Gift Tags, Business Gifts,

Invitations & Announcements,

Wedding Invitations, Save the Dates, Birthday Invitations, Birth Announcements, Baby Shower Invitations, Party Invitations, Moving Announcements, Graduation Invitations, Business Invitations, Religious Announcements, Holiday Cards,

Labels & Stickers,

Address Labels, Return Address Labels, Mailing Labels, Tags, Gift Tags, Name Tags, Stickers & Decals, Product Labels, Custom Stickers, Business Card Stickers, Bumper Stickers, Window Decals,

Magnets,

Car Door Magnets, Magnetic Business Cards, Postcard Magnets, Magnetic Calendars, Photo Magnets,

Marketing Materials,

Flyers Postcards, Postcard Mailing Services, Brochures, Door Hangers Rack Cards, Presentation Folders, Menus, Table Tents, Coasters, Paper Coasters, Photo Coasters, Bookmarks, Gift Certificates, Loyalty Cards, Magnets, Corporate Gifts, Promotional Products Holiday tips for your business.

Phone Cases

Photo Gifts

Personalized Mugs, Wall Calendars, Phone Cases, Desk Calendars, Canvas Prints, Premium Canvas Prints, Lightweight Canvas Prints, Photo Cards, Photo Books, Mouse Pads, Photo Magnets, Bookmarks, Pillows, Puzzles, Coasters, Photo Coasters, Paper Coasters, Promotional Products,

Signs & Posters

Banners, Posters, Lawn Signs, Lawn Signs, Political Signs, Construction Signs, Real Estate Signs, Car Door Magnets, Engraved Office Signs, Engraved Door Signs, Engraved Desk Signs, Window Decals, Plastic Signs, Bumper Stickers,

Stamps & Ink

Self-Inking Stamps, Pre-Inked Stamps, Signature Stamps, Date Stamps, Pocket Stamps, Embossers, Replacement Ink,

Stationery

Address Labels, Return Address Labels, Mailing Labels, Pens, Letterhead, Notebooks, Envelopes, Note Pads, Envelope Seals, Note Cards, Appointment Cards, Thank You Cards, Sticky Notes, Sticky Note Holders, Holiday Cards

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

I claim:

16. A light absorbent after-glow multilayered coating apparatus comprising;
a transparent light absorbent member composed of a fabric; and
a chemical compound incorporated therein, having a front and a back surface.

17. The light absorbent after-glow multilayered coating apparatus as set forth in claim 1, wherein said chemical compound is alkaline aluminate.

18. The light absorbent after-glow multilayered coating apparatus as set forth in claim 1, wherein an activating compound is applied on said light absorbent member composed of a fabric and a chemical compound.

19. The light absorbent after-glow multilayered coating apparatus as set forth in claim 1, wherein said activating compound is lanthanum.

20. The light absorbent after-glow multilayered coating apparatus as set forth in claim 1, wherein said at least one surface is adhesive.

21. The light absorbent after-glow multilayered coating apparatus as set forth in claim 1, wherein said back surface is adhesive.

22. The light absorbent after-glow multilayered coating apparatus as set forth in claim 1, wherein said apparatus is a sheet of paper.

23. The light absorbent after-glow multilayered coating apparatus as set forth in claim 1, wherein said apparatus is non-toxic.

24. The light absorbent after-glow multilayered coating apparatus as set forth in claim 1, wherein said apparatus is scentless.

25. The light absorbent after-glow multilayered coating apparatus as set forth in claim 1, wherein said apparatus is non-radioactive.

26. The light absorbent after-glow multilayered coating apparatus as set forth in claim 1, wherein said apparatus is detachably attached to an article.

27. The light absorbent after-glow multilayered coating apparatus as set forth in claim 1, wherein said apparatus provides an improved visual effect.

28. The light absorbent after-glow multilayered coating apparatus as set forth in claim 1, wherein said apparatus provides a three dimensional visual effect.

29. The light absorbent after-glow multilayered coating apparatus as set forth in claim 1, wherein said apparatus absorbs light exposed to it.

30. The light absorbent after-glow multilayered coating apparatus as set forth in claim 1, wherein said apparatus is fluorescent.
